(19) United States
(12) Patent Application Publication
(10) Pub. No.: US 2011/0314481 A1
(43) Pub. Date: Dec. 22, 2011

(54) DYNAMICALLY GENERATING AND DELIVERING INFORMATION IN RESPONSE TO THE OCCURRENCE OF AN EVENT

(76) Inventors: Steve L. Bernstein, (US); Peter M. Marshall, (US); Michael J. Rudolph, (US)

(21) Appl. No.: 13/039,262

(22) Filed: Mar. 2, 2011

Related U.S. Application Data
(63) Continuation of application No. 11/970,405, filed on Jan. 7, 2008, now abandoned.
Application No. 11/970,405 is a continuation of application No. 10/216,535, filed on Aug. 8, 2002, now abandoned.
(60) Provisional application No. 60/311,028, filed on Aug. 8, 2001.
(60) Provisional application No. 60/311,057, filed on Aug. 8, 2001.
(60) Provisional application No. 60/311,054, filed on Aug. 8, 2001.

(51) Int. Cl. G06F 9/46

(52) U.S. Cl. 719/318

(57) ABSTRACT

A facility for generating information in response to the occurrence of events is described. The facility detects the occurrence of one of a plurality of defined events. The facility matches the detected event occurrence against a set of scenarios. Each scenario specifies one or more matching rules, content, and a set of recipients. The facility aggregates the content specified by the subset of the set of scenarios whose matching rules are satisfied by the event occurrence for the recipients specified by this subset of scenarios.

### RELATED APPLICATIONS

The present application claims the benefit of the following three provisional patent applications, each of which is hereby incorporated by reference in its entirety: U.S. Patent Application No. 60/311,028, filed Aug. 8, 2001, entitled METHOD FOR ESTABLISHMENT AND COMMUNICATION OF BUSINESS CONTEXTS WITHIN COMPUTER NETWORKS; U.S. Patent Application No. 60/311,057, filed Aug. 8, 2001, entitled METHOD FOR DELIVERY OF DYNAMICALLY RETRIEVED RELEVANT CONTENT TO RECIPIENTS BASED ON THE INSTANTIATION OF THE ASSOCIATED CONTEXT; and U.S. Patent Application No. 60/311,054, filed Aug. 8, 2001, entitled METHOD FOR DEFINITION OF CONTENT RELEVANT TO BUSINESS CONTEXTS BY MULTIPLE INDEPENDENT ASYNCHRONOUSLY ACTING DEFINERS WITHIN SOFTWARE SYSTEMS.

### TECHNICAL FIELD

The present invention is directed to the field of content generation and delivery.

### BACKGROUND

In many large organizations, software is used to communicate data between people and systems. The data communicated using such software often contains information that would be of significant value to an organization if that information could be recognized, supplemented with additional information available within the organization, and delivered to appropriate recipients. Unfortunately, such software typically provides little functionality for deriving the full value of such information. Accordingly, a system that assisted an organization in taking advantage of such information would have significant utility.

### BRIEF DESCRIPTION OF THE DRAWINGS

FIG. 1 is a diagram showing a process typically performed by the facility to define the content associated with a event-related context.

FIG. 2 is a diagram showing how a management process typically communicates responsibility to a listening process in establishment of a context from event source and integration processes.

FIG. 3 is a diagram that shows overall operation of the facility to distribute content based upon defected event occurrences.

### DETAILED DESCRIPTION

A software facility for dynamically generating and delivering information—such as business information—in response to the occurrence of an event (“the facility”) is described. In particular, the facility establishes a business context from external sources and routes, delivers and uses this context to facilitate further action. The facility facilitates abstract interaction with any context source, as well as evaluating the data within the context and subsequently acting upon it. By interacting with the software used to communicate data between people and systems, the facility identifies valuable business activities by either directly monitoring the changes to the underlying persistent data of the software, through a registration or subscription capability of the software, or through an enterprise application integration (EAI) product.

The data relevant to an activity may be contained entirely within the data of the event source system or may be distributed across several other systems. Often, the data that is distributed across the organization may not even be completely available at a given time, so that the entire context of the event cannot be determined until a later time. Accordingly, embodiments of the facility facilitate establishing a context across several heterogeneous systems over a time period.

Once a context is established, it is generally only valuable to an organization if something can be done with it. Accordingly, embodiments of the facility provide routing and delivery of the data to other processes that can act upon the complete set of data relevant to the context. Typically this will involve delivering relevant, dynamically aggregated data regarding the activity to another process. In some cases, this will deliver the complete context to a workflow/BPM product, such as those from IBM or Versata. In some embodiments, the facility includes tools usable to define these events, the set of information that is delivered in response to the events, the set of recipients to which this information is delivered, or any combination thereof.

In some embodiments, the facility performs the high-level sequence of steps shown below in Table 1:

TABLE 1

| | |
|---|---|
| 1. | defining a set of events in response to occurrences of which |
| | business information may be delivered |
| 2. | detecting the occurrence of a defined event |
| 3. | submitting the detected event occurrence for processing |
| 4. | matching the submitted event occurrence against a set of |
| | scenarios, each specifying: matching rules; content that is responsive |
| | or otherwise related to the event occurrence; and a set of recipients |
| | that are to receive the specified content |
| 5. | constructing one or more contexts by aggregating the content |
| | specified by the subset of scenarios whose matching rules are |
| | satisfied by the event for the recipients specified by this subset |
| | of scenarios |
| 6. | delivering the constructed context containing the aggregated |
| | content to the recipients specified by the satisfied scenarios |

These steps are typically performed automatically, and within a short time of the occurrence of the event so that the constructed contexts are regularly received by the appropriate recipients shortly after the event occurs.

As one example, the facility may detect and submit occurrences of events including a “new hire” event, in which a new employee joins the company that is using the facility. Such an event may be detected in several different ways, including: periodically polling a personnel database listing all employees to identify any new rows in the database corresponding to new employees; configuring such a personnel database to asynchronously notify the facility when such a new row is added; having an employee manually generate the event, such as by filling in and submitting a web-based form. In each case, information relating to the event occurrence that is needed to match the events with scenarios is stored as part of the event. In the case of the new hire event, the facility stores in each event occurrence the identity of the new employee, the new employee's job category, and the location in which the new employee will work.

The rules of several different scenarios may require that the event occurrence be an occurrence of the new hire event in order for the scenario to match the event occurrence. One or more of these scenarios may impose no further requirements via its rules. Such scenarios will be included in the contexts generated for all new hire event occurrences, and specify sending particular content to particular recipients irrespective of the details about the new employee. For example, such scenarios may specify sending a very general employee handbook to the new employee (sample scenario 1), and sending instructions to an employee in the payroll department instructing him or her to add the new employee to the payroll database (sample scenario 2). Other scenarios may impose additional requirements to match a particular subset of new employees. For example, one scenario may send a company policy regarding the handling of sensitive information to new employees whose job category will give them access to sensitive information (sample scenario 3), while another may send instructions to an employee in the IT department to deliver and install a computer system in the office of new employees whose job category indicates that they will be supplied with a computer (sample scenario 4). A scenario may specify several different pieces of content, which may be retrieved from appropriate sources within or without the facility, and within or without the computer systems of the company using the facility. A scenario may specify recipients based upon identities contained in the event occurrence, absolute roles, roles that are relative to some individual such as an individual identified in the event occurrence, etc.

Once it is determined which scenarios' rules are satisfied by the event occurrence, the content specified by these scenarios is synthesized into a context for each of the specified recipients. For example, if all four of the sample scenarios were matched by a particular occurrence of the new hire event, the contexts shown below in Table 2 would be synthesized and delivered:

TABLE 2
a first context containing both the employee handbook and the
sensitive information-handling policy, delivered to the new employee
a second context containing the instructions to add the new
employee to the payroll database, delivered to an employee in the payroll
department
a third context containing the instructions to install a computer for
the new employee, delivered to an employee in the IT department

The generated contexts may be delivered to the specified recipients in a variety of ways, such as via email or instant message, or by inclusion in the version of the company portal that is displayed to the recipient. The contexts may be heavily organized, such as an HTML or XML web page constructed from a template and incorporating content retrieved from different sources. The contexts may specify a sequence or other set of tasks to be performed by the recipient in response to the event occurrence, and may track the recipient's performance of these tasks, both for the benefit of the recipient and others, such as the recipient's supervisor.

The facility may be used to support business activities of various different sorts. For example, in support of sales activities, the facility may detect the occurrence of events such as (1) a particular period of time has expired since an existing customer submitted its last order; (2) a non-customer has taken an action indicating interest in the company's products; (3) an external source of news has indicated that a non-customer company has entered a business for which the company's product provides support; (4) a customer has submitted a technical support request that reflects a need by the customer for a more advanced version of the product the customer is presently using. Content delivered in response to occurrences of such events may be fairly general, such as lists of general selling tips, or may be more tailored to the specific details of the event occurrence, such as contact information for the salespeople involved with the last three successful sales in the same industry as the prospect identified in the event occurrence; case studies involving the same product in which the prospect identified in the event occurrence is interested; or account history information for the customer identified in the event occurrence.

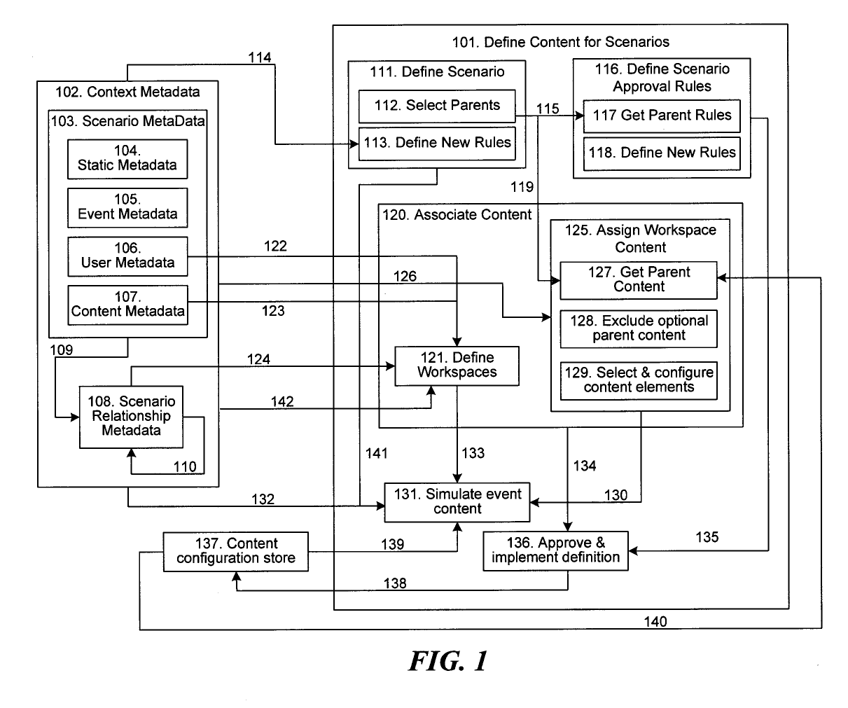

FIG. 1 is a diagram showing a process typically performed by the facility to define the content associated with a event-related context. The diagram shows the internal structure of the content metadata infrastructure, with specific metadata sub-methods and a relationship method supporting complex, composite linkages of metadata elements, and the method for assigning content to context, which includes defining scenarios and approval rules, associating content, defining approval processes, and staging of approved configurations to a persistent store.

The basic architecture shown includes a context metadata infrastructure 102, which defines and describes data sources that can be used to establish a context from relevant content. The context metadata infrastructure includes various types of scenario metadata 103, including static metadata 104, event metadata 105, user metadata 106, and content metadata 107. The context metadata infrastructure further includes relationship metadata 108, which consists of rules for determining an output set of metadata elements from an input set. Relationship rules may be implemented within the context metadata as composite expressions constructed of joins 109 between members of the input and output sets over the values of selected attributes of the two sets, and other relationships 110. Relationships may also be implemented external to the context metadata by content providers. This infrastructure supports a framework 101 within which prescribers of and subscribers to content can define relevant content by select triggering events of interest as defined by the event metadata method 105, define a specific context of content already associated for any and all subsets of that context 127, and extend that context with new content associations 120.

Content is organized 121 into workspaces for specified recipients and with specified delivery media and formatting. Recipients are defined by expressions that resolve to users or groups, and may include relationships to elements of the event context, which are constructed from the elements available via the interfaces 121, 123, 124 to the user, content, and relationship metadata infrastructures 106, 107, 108 that are derivable from the specific business event of the context. Changes to or extensions of any context are governed by approval rules defined 116 for any subset of the context 117 or for the specific extension 118. All configuration is performed by completing expressions 113, 121, 129 that define the value of configuration parameters, which are constructed from elements available via the interfaces 114, 122, 126 to the context metadata infrastructure 102 that are derivable from the specific business event of the context. The content associated with the context of a sample event may be viewed using the simulator 131, which will determine all scenarios for a sample event via the interface 139 to the content configuration store 137, and the interfaces 130, 133 to a working configuration 125, 121, evaluating all expressions used to define the scenario rules via the interface 132 to the context metadata infrastructure 12 and content.

In some embodiments, a set of experts within an enterprise each define the usage of content for which they are responsible.

Administrators may configure metadata for static values and context-free functions 104, events 105, user data 106, and various content sources 107, describing the data structures, formats, instructions, and user interface settings, and for the entity relationships 108, defining the script to implement the relationship, constructed from other context metadata elements. There may be relationships that are defined in the context metadata that are not constructed, so that the implementation is left to specific content data providers, to be implemented independently of the context metadata infrastructure.

Experts can define a scenario of interest, and associate content to it. Scenarios are aggregations of rules about a business event. Scenarios are defined as extensions of optional previously defined “parent” scenarios 112, plus optional scenario-specific rules 113. The rules to be evaluated to determine whether a scenario is true are the rules associated with the parent scenarios plus the scenario-specific rules. If parent rules change, the children automatically inherit the changes. Rules are constructed from elements available via the interface 114 to the context metadata infrastructure 102 that are derivable from the specific business event of the context.

In some embodiments, changes to a scenario, including assignment of any content or modification of any content configuration, require the approval of all parties specified by the approval rules 116. A method 118 exists to explicitly define the approvers of a scenario, which evaluates to users. Approvers of a parent scenario may be specified 117 as cascading to child scenarios, which supplement the approvers that were defined explicitly.

In some embodiments, the expert will navigate a user interface 120 that provides a representation of the scenario definition 119 and associated content 121, 125, including content that has been assigned to parent scenarios 127. The experts define delivery modes (workspaces) for content, configuring the recipient users, and the content style and delivery service, and optionally the schedule for workspace delivery. The expert does so by defining the values of configuration parameters for those elements, as expressions constructed from elements available via the interface 123 to the content metadata infrastructure 107, and the interface 122 to the user metadata infrastructure 106, and the interface 124 to the relationship metadata infrastructure 108 that are derivable from the specific business event of the context.

The expert assigns content to workspaces and configure context-specific parameter values for the content, by completing expressions that define the value of configuration parameters, which are constructed from elements available via the interface 126 to the context metadata infrastructure 102 that are derivable from the specific business event of the context. Assignments may be set as mandatory or optional. Content assigned by parent scenarios may be unassigned 128 (i.e., excluded) if the parent assignment was optional.

The expert may work over one or more sessions, in parallel with other experts that are independently making simultaneous modifications. When ready, in the preferred embodiment, the expert may test the overall behavior of the current configuration 137, 111, 121, 125 by simulating events 131. The expert defines a sample business event, which is then processed as if the current configuration were in production, using the interface 132 to the context metadata infrastructure 102 to evaluate the values of all expressions used to define associated scenario rules, and configure workspaces and content, as selected via interfaces 130, 133, 141 from the current session configuration changes, and 139 from the current production configuration. The simulator includes presentation to the expert for inspection of samples of all workspaces to be dispatched, but without any actual dispatch of workspaces. When ready, in the preferred embodiment, the expert may submit 134 a staging 138. Information about the request, including current and proposed state, itemized changes, and the current status of all required approvals is routed to all approvers, as determined via the interface 135 to the scenario approval rules 116, in a workspace that allows the approver to click to approve or deny the request. If any approver denies, then the request is denied. If all approvers approve, then the facility automatically migrates 138 the request to the production configuration 137 on the effective date.

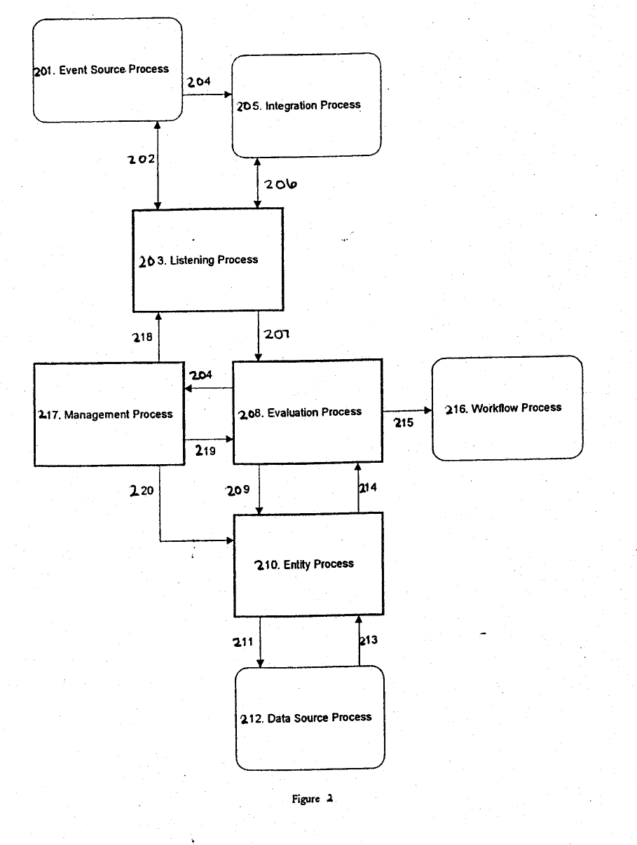

FIG. 2 is a diagram showing how a management process typically communicates responsibility to a listening process in establishment of a context from event source and integration processes. The diagram further shows typical resulting communication from the listening process to other processes upon occurrence of activity. The diagram further shows the facility contacting systems or processes outside of the original system or process to fully qualify a context.

The facility typically creates at least one listening process 203, an evaluation process 208, at least one entity process 210, and a management process 217.

As part of the method of context determination, the aforementioned processes communicate with four types of external processes: an event source process 201, an integration process 205, a data source process 212, and a workflow process 216.

In typical usage, an event source process 201 may be a database that is continuously being updated by a software application. The event source process 201 will reflect the first potential realization of the business context based on the insertion, deletion or modification of its data. The occurrence of this data will be communicated to the listening process 203 through one of several mechanisms.

The listening process 203 may directly communicate 202 with the event source process 201. Depending on the type of event source process 201, the listening process 203 may poll the event source process 201 with a specified frequency and period. During this polling, the listening process 203 would utilize whatever protocol is necessary to determine the desired occurrence of data.

Additionally, an integration process 205 may be utilized to facilitate the detection of the data in the event source process 201 by the listening process 203. An integration process 205 generally does not actually contain the data that the listener process 203 is responsible for detecting, but helps facilitate the detection. Typically, the listener process 203 registers 206 itself with the integration process 205, which in turn communicates with the event source process 204 through some means. When the desired data occurs, it is then communicated 204 to the integration process 205 and in turn communicated 206 to the listening process 203.

Once a listening process 203 detects the desired data, it communicates 207 that data to an evaluation process 208. This communication 207 also contains information regarding the listening process 203 that detected the data and the time the data was detected.

The evaluation process 208 is typically configured by the management process 217 in such a manner that it understands how to fully qualify the data 207 by communicating with an entity process 210. In many cases, all of the data necessary to complete a context will not be available in the base data made available in the event source process 201, and other data source processes 212 will need to be queried.

The evaluation process 208 issues a request 209 to the entity process 210 to retrieve data 211 from one or more data source processes 212. This request 209 typically contains a subset of data extracted from the event source data, and may potentially include transformations made to that data as specified in the management process 217. The results 213 of the query 211 to the data source 212 are returned to the entity process 210, which in turn returns 214 them to the evaluation process 208.

Through the acquisition of data from a listening process 203 and one or more entity processes 210, the evaluation process 208 retrieves all of the data necessary to complete the desired business context. Once completed, it delivers 215 the complete set of data to a workflow process 216 where any form of action can be taken on that data. Often, the workflow process is a software implementation that may use the context as a trigger for some workflow, which may or may not include delivery of this data—as well as other data—to specified recipients.

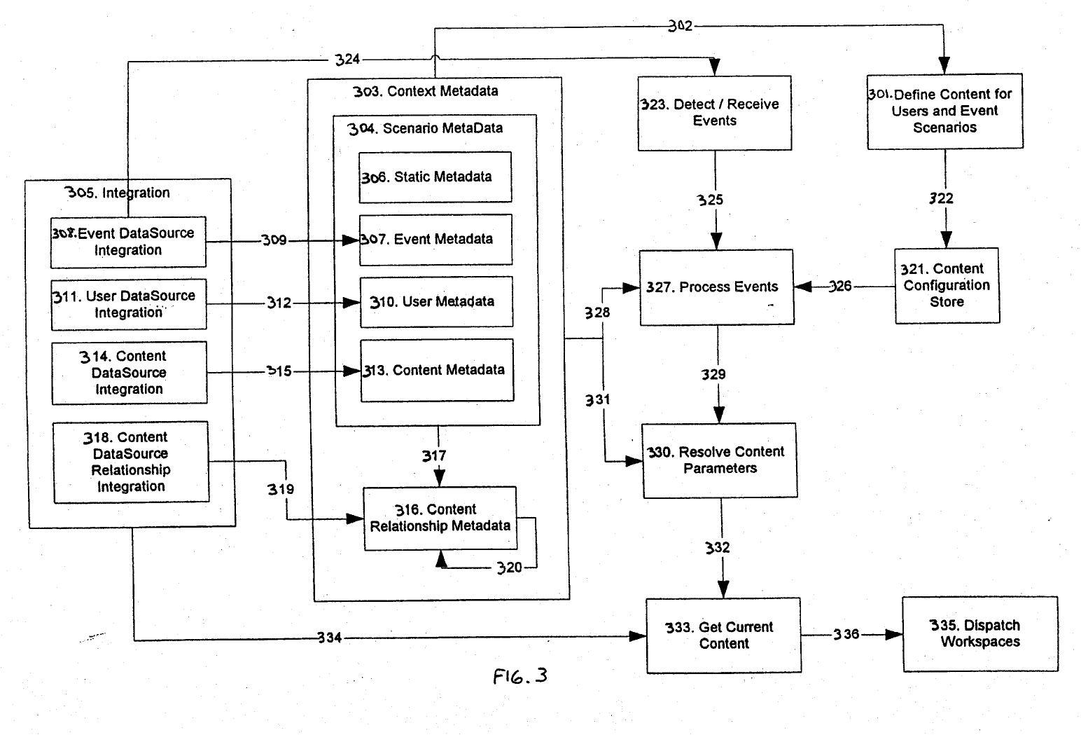

FIG. 3 is a diagram that shows overall operation of the facility to distribute content based upon defected event occurrences. In particular, it shows 1) the relationships and process flow between the metadata and integration infrastructures, 2) the internal structure of the content metadata infrastructure, with specific metadata sub-methods and a relationship method supporting complex, composite linkages of metadata elements, 3) the method for assigning content to context, 4) the methods for receiving and processing actual business event instances, and 5) the methods for getting, formatting, and dispatching content associated with the complete context associated with event instances.

The operation of the facility shown includes receiving messaging of event instances; determining the complete context; determining, retrieving, formatting, and aggregating all relevant content; and dispatching the content to defined human and system recipients. Administrators typically configure metadata for static values and context-free functions 306, events 307, user data 310, and various content sources 313, describing the data structures, formats, instructions, and user interface settings, and for the entity relationships 316, defining the script to implement the relationship, constructed from other context metadata elements. There may be relationships that are defined in the context metadata that are not constructed, so that the implementation is left to specific content data providers, to be implemented independently of the context metadata infrastructure.

Administrators typically configure data source integration services for events, user data 311, various content sources 314, and data-source specific implementations 318 of binary relationships between content elements (“entities”) 316, either within the same source or across two sources, that defines a set of entities based on the values of one or more attributes of an entity.

Integration services support a common interface 334 for retrieving data, used to support event data access 309, user data access 312, and content data access 315, and will support a relationship interface 319 to data-source-specific implementations of access to related entities.

Administrators also typically configure metadata for static values and context-free functions 306, events 307, user data 310, and various content sources 313, describing the data structures, formats, instructions, and user interface settings, and for the entity relationships 316, defining the script to implement the relationship, constructed from other context metadata elements.

Event integration services 308 are configured to either receive messages when event instances occur or poll data sources for the occurrence of a set of conditions that define an event and extract the parameters of an event message. In either case, they forward the event instance message 324 to the system for receiving events 323, implemented as an XML stream to a guaranteed message-delivery queue.

Experts define a scenario of interest, and associate content with it. Scenarios are aggregations of rules about a business event. The expert defines delivery modes (workspaces) for relevant content, configuring the recipient users, and the content style and delivery service, and optionally the schedule for workspace delivery, by defining the values of configuration parameters for those elements, as expressions constructed from elements available via the interface 302 to the context metadata infrastructure 303 that are derivable from the specific business event of the context. The expert assigns content to workspaces and configures context-specific parameter values for the content, by completing expressions that define the value of configuration parameters, which are constructed from elements available via the interface 302 to the context metadata infrastructure 303 that are derivable from the specific business event of the context. The results of this configuration are managed in a production store 321.

Actual business events are received from event source integration services 308 via the event message process 324 to the event queue 323. Event processor methods 327 retrieve events that match their configuration from the queue 323, and evaluate scenarios retrieved via cache 326 from the production configuration 321. The processor parses each expression of the scenario rules, and retrieves the value of each element of the expressions via the interface 328 to the context metadata infrastructure 303. For each workspace and each recipient associated with the complete context (i.e., the set of true scenarios) per the production configuration 321, the event processor will call 329 the content processor 330 to resolve the content configuration parameters via the interface to the context metadata infrastructure 303. When the workspace is to be dispatched, these parameters will be passed to the content integration infrastructure 305 by the workspace generator 333, with current content passed back via XML 334, and forwarded 336 to the dispatch service appropriate dispatch service 335.

It will be appreciated by those skilled in the art that the above-described facility may be straightforwardly adapted or extended in various ways. While the foregoing description makes reference to preferred embodiments, the scope of the invention is defined solely by the claims that follow and the elements recited therein.

1. A method in a computing system having a processor for generating information in response to the occurrence of events, comprising:
detecting the occurrence of one of a plurality of defined events;
with the processor, matching the detected event occurrence against a set of scenarios, each scenario specifying (a) one or more matching rules; (b) content that is responsive or otherwise related to event occurrences satisfying the matching rules; and (c) a set of recipients that are to receive the specified content for event occurrences satisfying the matching rules; and
constructing one or more contexts by aggregating the content specified by the subset of the set of scenarios whose matching rules are satisfied by the event occurrence for the recipients specified by this subset of scenarios.

2. The method of claim 1, further comprising delivering the constructed contexts containing the aggregated content to the recipients specified by the scenarios whose matching rules are satisfied.

3. The method of claim 2 wherein the constructed contexts are delivered by electronic means.

4. The method of claim 2 wherein the constructed contexts are delivered promptly after occurrence of the event.

5. The method of claim 1, further comprising defining one of the plurality of defined events by specifying a mechanism for detecting occurrences of the event.

6. The method of claim 5 wherein the defined event is a business event.

7. The method of claim 5 wherein the specified mechanism is periodically polling a specified data source for specified changes within the data source.

8. The method of claim 5 wherein the specified mechanism is directing a specified data source to generate asynchronous notifications for specified changes within the data source.

9. The method of claim 5 wherein the specified mechanism is receiving a manually-generated indication that the event has occurred.

10. The method of claim 1, further comprising receiving user input defining one of the defined events.

11. The method of claim 1, further comprising defining one of the set of scenarios.

12. The method of claim 1 wherein the defined scenario specifies external content.

13. The method of claim 1 wherein the defined scenario specifies a manner of organizing the specified content.

14. The method of claim 1, further comprising receiving user input defining one of the set of scenarios.

15. The method of claim 1 wherein at least a portion of the content specified by the scenario is specified by reference, and wherein the construction of the context includes dereferencing the specified references to dynamically retrieve the content.

16. The method of claim 1 wherein at least a portion of the content specified by the scenario is specified by reference, and wherein the construction of the context includes dereferencing the specified references to dynamically generate the content.

17. A computer-readable medium whose contents cause a computing system to generate information in response to the occurrence of events by:
detecting the occurrence of one of a plurality of defined events;
matching the detected event occurrence against a set of scenarios, each scenario specifying (a) one or more matching rules; (b) content; and (c) a set of recipients; and
aggregating the content specified by the subset of the set of scenarios whose matching rules are satisfied by the event occurrence for the recipients specified by this subset of scenarios.

18. The computer-readable medium of claim 17 wherein the contents of the contents of the computer-readable medium further cause the computing system to deliver the aggregated content to the recipients specified by the scenarios whose matching rules are satisfied.

19. A system for establishing a context, comprising:
a listening subsystem that receives activity data from one or more event sources;
a routing subsystem that routes the activity data received by the listening subsystem; and
a context construction subsystem that constructs a context for the data routed by the routing subsystem.

20. The system of claim 19, further comprising:
an integration subsystem that facilitates listening by the listening subsystem to the event sources.

21. The system of claim 19, further comprising:
a management subsystem to configure the listening and routing subsystems.

22. The system of claim 19, further comprising:
an activity handling subsystem that receives activity data from the routing subsystem for further handling or delegation.

23. One or more computer memories collectively storing an event response data structure, comprising, for each of a plurality of scenarios:
information specifying one or more matching rules against which details of event occurrences may be evaluated;
information specifying content that is responsive or otherwise related to the event occurrences satisfying the specified matching rules; and
information specifying one or more recipients that are to receive the specified content for event occurrences satisfying the matching rules,
such that the contents of the event response data structure may be used to identify scenarios that are responsive to event occurrences, collect corresponding content, and deliver it to one or more recipients.
